(19) United States
(12) Patent Application Publication
(10) Pub. No.: US 2026/0105726 A1
(43) Pub. Date: Apr. 16, 2026

(54) DISASTER SMOKE DETECTION METHOD BASED ON DEEP CONVOLUTIONAL NEURAL NETWORK

(71) Applicant: SUN YAT-SEN UNIVERSITY, Guangdong (CN)

(72) Inventors: Yu HAN, Guangdong (CN); Jianyuan TAO, Guangdong (CN); Ying SHEN, Guangdong (CN)

(21) Appl. No.: 19/349,656

(22) Filed: Oct. 3, 2025

(30) Foreign Application Priority Data
Oct. 10, 2024 (CN) 202411406177.1

(51) Int. Cl. G06V 10/77; G06T 5/20; G06V 10/25; G06V 10/764; G06V 10/80

(52) U.S. Cl. CPC G06V 10/7715; G06T 5/20; G06V 10/25; G06V 10/764; G06V 10/806; G06V 2201/07

(57) ABSTRACT

A disaster smoke detection method includes: performing a first convolution operation on an input image to extract features to generate a primary feature map; performing enhancement processing on the primary feature map to obtain an enhanced feature map; performing multi-scale fusion on the enhanced feature map according to a second convolution operation to obtain a plurality of feature maps of different scales as high-level feature maps; respectively performing top-down feature fusion and bottom-up feature fusion on each high-level feature map at each scale according to a third convolution operation to correspondingly obtain a plurality of top-down fused feature maps and a plurality of bottom-up fused feature maps; fusing the top-down fused feature maps and the bottom-up fused feature maps to obtain a plurality of bidirectional cross-fused feature maps; and performing disaster and smoke detection on each of the bidirectional cross-fused feature maps.

### CROSS-REFERENCE TO RELATED APPLICATIONS AND PRIORITY

This patent application claims priority from Chinese Patent Application No. 202411406177.1 filed Oct. 10, 2024. This patent application is herein incorporated by reference in its entirety.

### TECHNICAL FIELD

The present disclosure relates to the technical field of image processing, and particularly to a disaster smoke detection method and system based on a deep convolutional neural network.

### BACKGROUND

Flame detection and smoke detection hold significant application value in the fields of fire disaster prevention and safety monitoring. Especially in early fire alarm systems, the rapid and accurate detection of flames and smoke is crucial. At present, conventional detection methods mainly rely on image processing techniques based on low-level features such as color, shape, and motion, and can provide reliable detection results in simple backgrounds. However, when faced with complex backgrounds, significant changes in lighting conditions, or other disturbances, the detection accuracy and robustness of the conventional methods tend to be greatly reduced.

### SUMMARY

A main objective of embodiments of the present disclosure is to provide a disaster smoke detection method and system based on a deep convolutional neural network, to improve the accuracy and robustness of disaster smoke detection.

To achieve the above objective, in accordance with one aspect of the present disclosure, an embodiment provides a disaster smoke detection method based on a deep convolutional neural network, including:
performing a first convolution operation on an input image to extract features to generate a primary feature map;
performing enhancement processing on the primary feature map to obtain an enhanced feature map;
performing multi-scale fusion on the enhanced feature map according to a second convolution operation to obtain a plurality of feature maps of different scales as high-level feature maps;
respectively performing top-down feature fusion and bottom-up feature fusion on each high-level feature map at each scale according to a third convolution operation to correspondingly obtain a plurality of top-down fused feature maps and a plurality of bottom-up fused feature maps;
fusing the top-down fused feature maps and the bottom-up fused feature maps to obtain a plurality of bidirectional cross-fused feature maps; and
performing disaster and smoke detection on each of the bidirectional cross-fused feature maps.

In some embodiments, the performing a first convolution operation on an input image to extract features to generate a primary feature map includes:
performing a convolution operation on the input image through a spatial and channel reconstruction convolution module to obtain a basic feature map,
where the convolution operation of the spatial and channel reconstruction convolution module is expressed as the following formula:

$${X}^{′} = ScConv ( X ) = {σ}_{act} ( BN ( CRU ( SRU ( Conv ( X ) ) ) ) ) ,$$

where X′ represents the basic feature map; ScConv represents a spatial and channel reconstruction convolution operation; Conv(X) represents a convolution operation of the input image X with a weight W, with a kernel size of k×k and a stride s, using automatic padding p to adjust a size of a feature map to be outputted; SRU(X) is used for handling spatial redundancy; CRU(X) is used for handling channel redundancy; BN(·) represents a batch normalization operation; and σ_{act}(·) represents an SiLU activation function; and
performing a convolution operation on the basic feature map through a residual block to obtain the primary feature map,
where the convolution operation of the residual block is expressed as the following formula:

$$F ( {X}^{′} ) = {ScConv}_{2} ( {σ}_{act} ( {BN}_{1} ( {ScConv}_{1} ( {X}^{′} ) ) ) ) ;$$

and
residual connection of the residual block is expressed as the following formula:

$${Y}^{′} = {x}^{′} + F ( {X}^{′} ) ,$$

where ScConv₁ and ScConv₂ represent two consecutive spatial and channel reconstruction convolution operations, F(X′) represents a convolved feature mapping, and Y′ the primary feature map.

In some embodiments, the performing enhancement processing on the primary feature map to obtain an enhanced feature map includes:
generating a weight matrix corresponding to the primary feature map through a convolution operation of an attention mechanism, and performing element-wise multiplication on the weight matrix and the primary feature map to obtain a first intermediate feature map,
where the convolution operation of the attention mechanism is expressed as the following formula:

$$A = Sigmoid ( {Conv}_{a t t} ( {Y}^{′} ) ) ,$$

where A represents the weight matrix, Convₐₜₜ represents the convolution operation that generates the weight matrix, and Sigmoid represents a function for generating a normalized output; and the first intermediate feature map is defined as Z′, and Z′=A⊙Y′;
generating an offset amount of a deformable convolutional layer of the first intermediate feature map through a local convolution operation, and performing a deformable convolution operation according to the offset amount of the deformable convolutional layer and the first intermediate feature map to obtain a second intermediate feature map,
where the offset amount of the deformable convolutional layer is expressed as the following formula:

$$Δ p = C o n {v}_{offset} ( {Z}^{′} ) ;$$

and
where the deformable convolution operation is expressed as the following formula:

$${Z}^{″} = DeformConv ( {Z}^{′} , Δ p ) ,$$

where Δp represents the offset amount of the deformable convolutional layer, Conv_{offset} represents a convolution operation of an independent convolutional layer, DeformConv represents the deformable convolution operation, and Z″ represents the second intermediate feature map;
performing Gabor filtering processing on the second intermediate feature map to obtain a filtered feature map,
where the Gabor filtering processing is expressed as the following formula:

$$G ( x , y ) = exp ( - \frac{{x}^{2} + {γ}^{2} {y}^{2}}{2 {σ}_{gabor}^{2}} ) cos ( 2 π \frac{x}{λ} + ψ ) ,$$

where σ_{gabor} is used for controlling a width of a Gaussian function, γ is used for controlling an aspect ratio of an elliptical Gaussian distribution, λ represents a wavelength, ψ represents a phase offset, and x, y represents pixel coordinates; and
adjusting a brightness and contrast of the filtered feature map to obtain the enhanced feature map.

In some embodiments, the performing multi-scale fusion on the enhanced feature map according to a second convolution operation to obtain a plurality of feature maps of different scales as high-level feature maps includes:
performing maximum pooling operations of different scales on the enhanced feature map to obtain a plurality of maximum pooled feature maps;
splicing the maximum pooled feature maps to obtain a spliced feature map, and inputting the spliced feature map to a target convolutional layer for fusion to obtain a multi-scale feature map; and
enhancing a feature of a target region in the multi-scale feature map through an attention mechanism to obtain the high-level feature maps.

In some embodiments, the respectively performing top-down feature fusion and bottom-up feature fusion on each high-level feature map at each scale according to a third convolution operation to correspondingly obtain a plurality of top-down fused feature maps and a plurality of bottom-up fused feature maps includes:
converting a number of channels of each of the high-level feature maps to a consistent dimension through a 1×1 convolution operation to obtain a plurality of converted feature maps;
starting from the converted feature map of a highest layer of the scale, propagating the converted feature maps downward layer by layer through interpolation upsampling, and performing weighted fusion with the converted feature map of a next layer to obtain a first fused feature map,
where the first fused feature map is expressed as the following formula:

$${P}_{i}^{TD} = {α}_{i , 1} \cdot {P}_{i} + {α}_{i , 2} \cdot Up ( {\tilde{P}}_{i + 1}^{TD} ) ,$$

where

$${P}_{i}^{T D}$$

represents the first fused feature map, Pᵢ represents the converted feature map, Up(·) represents an upsampling operation,

$${\tilde{P}}_{i + 1}^{T D}$$

represents a feature map obtained by depthwise separable convolution, α_{i,1} and α_{i,2} represent learnable first fusion weights, and the first fusion weights are constrained to be non-negative by a ReLU function;
starting from the converted feature map of a lowest layer of the scale, propagating the converted feature maps upward layer by layer through downsampling, and performing weighted fusion with the converted feature map of a previous layer to obtain a second fused feature map,
where the second fused feature map is expressed as the following formula:

$${P}_{i}^{BU} = {β}_{i , 1} \cdot {P}_{i}^{TD} + {β}_{i , 2} \cdot {\tilde{P}}_{i} + {β}_{i , 3} \cdot Down ( {P}_{i - 1}^{BU} ) ,$$

where

$${P}_{i}^{BU}$$

represents the second fused feature map, Down(·) represents a downsampling operation, \tilde{P}ᵢ represents a feature map obtained by depthwise separable convolution, and β_{i,1}, β_{i,2}, and β_{i,3} represent learnable second fusion weights; and
adjusting the first fusion weights and the second fusion weights according to a minimization loss function through a back propagation algorithm, generating the top-down fused feature maps using the adjusted first fusion weights, and generating the bottom-up fused feature maps using the adjusted second fusion weights,
where the minimization loss function is expressed as the following formula:

$$L = {\sum }_{i = 2}^{6} {L}_{t a s k} ( {F}_{i}^{T D} , {F}_{i}^{BU} ) ;$$

where the top-down fused feature map is expressed as the following formula:

$${F}_{i}^{TD} = {α}_{i , 1} \cdot {P}_{i}^{TD} + {α}_{i , 2} \cdot Up ( {F}_{i + 1}^{TD} ) ;$$

and
where the bottom-up fused feature map is expressed as the following formula:

$${F}_{i}^{BU} = {β}_{i , 1} \cdot {P}_{i}^{BU} + {β}_{i , 2} \cdot {P}_{i} + {β}_{i , 3} \cdot Down ( {F}_{i - 1}^{BU} ) ,$$

where L represents the minimization loss function,

$${F}_{i}^{T D}$$

represents the top-down fused feature map,

$${F}_{i}^{BU}$$

represents the bottom-up fused feature map, and i represents a hierarchical sequence number of the converted feature map; and
the fusing the top-down fused feature maps and the bottom-up fused feature maps to obtain a plurality of bidirectional cross-fused feature maps includes:
determining an optimized fusion weight according to the adjusted first fusion weights and the adjusted second fusion weights; and
fusing the top-down fused feature maps and the bottom-up fused feature maps according to the optimized fusion weight to obtain the plurality of the bi-directional cross-fused feature maps,
where the bidirectional cross-fused feature map is expressed as the following formula:

$${F}_{i} = {Σ}_{i = 2}^{6} {γ}_{i} \cdot ( {F}_{i}^{TD} + {F}_{i}^{BU} ) ,$$

where Fᵢ represents the bidirectional cross-fused feature map, and γᵢ represents the optimized fusion weight.

In some embodiments, the performing disaster and smoke detection on each of the bidirectional cross-fused feature maps includes:
identifying categories of objects in each of the bidirectional cross-fused feature maps through a classification convolution operation to obtain a classification result, where the objects include disaster and smoke; and
the classification result is expressed as the following formula:

$${F}_{i , cls} = {σ}_{c l s} ( B N ( C o n {v}_{c l s} ( {F}_{i} ) ) ) ,$$

where F_{i,cls} represents the classification result, Conv_{cls} represents the classification convolution operation, BN(·) represents a batch normalization operation, σ_{cls}(·) represents an activation function of classification convolution, and Fᵢ represents the bidirectional cross-fused feature map;
determining a probability of each of the objects according to the classification result and generating a confidence level of each of the probabilities,
where a probability distribution of each of the objects is expressed as the following formula:

$$P ( C \vert {F}_{i} ) = Soft max ( {F}_{i , cls} ) ,$$

where P(C|Fᵢ) represents the probability distribution, C represents the probability, and Softmax represents an activation function;
outputting a bounding box parameter for each of the objects in each of the bidirectional cross-fused feature maps through a regression convolution operation,
where the bounding box parameter is expressed as the following formula:

$$B ( {F}_{i} ) = C o n {v}_{reg} ( {F}_{i} ) ,$$

where B(Fᵢ) represents the bounding box parameter, and Conv_{reg} represents the regression convolution operation; and
determining the probability of each of the objects, the confidence level of each of the probabilities, and the bounding box parameter of each of the objects as a detection result of the disaster and smoke detection,
where the detection result is expressed as the following formula:

$${O}_{i} = \{ ( C , S ( C \vert {F}_{i} ) , B ( {F}_{i} ) ) \} ,$$

where Oᵢ represents the detection result, and S(C|Fᵢ) represents the confidence level.

In some embodiments, the method further includes:
optimizing the bounding box parameter using a distributed focal loss to obtain an optimized bounding box parameter,
where the optimized bounding box parameter is expressed as the following formula:

$${B}^{′} ( {F}_{i} ) = DFL ( B ( {F}_{i} ) ) ,$$

where B′(Fᵢ) represents the optimized bounding box parameter, and DFL represents the distributed focal loss; and
updating the detection result according to the optimized bounding box parameter,
where the updated detection result is expressed as the following formula:

$${O}_{i} = \{ ( C , S ( C \vert {F}_{i} ) , {B}^{′} ( {F}_{i} ) ) \} .$$

To achieve the above objective, in accordance with another aspect of the present disclosure, an embodiment provides a disaster smoke detection system based on a deep convolutional neural network, including:
a feature extraction unit configured for performing a first convolution operation on an input image to extract features to generate a primary feature map;
a feature enhancement unit configured for performing enhancement processing on the primary feature map to obtain an enhanced feature map;
a first feature fusion unit configured for performing multi-scale fusion on the enhanced feature map according to a second convolution operation to obtain a plurality of feature maps of different scales as high-level feature maps;
a second feature fusion unit configured for respectively performing top-down feature fusion and bottom-up feature fusion on each high-level feature map at each scale according to a third convolution operation to correspondingly obtain a plurality of top-down fused feature maps and a plurality of bottom-up fused feature maps;
a bidirectional cross-fusion unit configured for fusing the top-down fused feature maps and the bottom-up fused feature maps to obtain a plurality of bidirectional cross-fused feature maps; and
an object detection unit configured for performing disaster and smoke detection on each of the bidirectional cross-fused feature maps.

To achieve the above objective, in accordance with another aspect of the present disclosure, an embodiment provides an electronic device, including a memory and a processor. The memory has a computer program stored therein. The computer program, when executed by the processor, causes the processor to implement the method described above.

To achieve the above objective, in accordance with another aspect of the present disclosure, an embodiment provides a computer-readable storage medium, having a computer program stored therein. The computer program, when executed by a processor, causes the processor to implement the method described above.

The embodiments of the present disclosure at least include the following beneficial effects:

The method of the present disclosure includes: performing a first convolution operation on an input image to extract features to generate a primary feature map; performing enhancement processing on the primary feature map to obtain an enhanced feature map; performing multi-scale fusion on the enhanced feature map according to a second convolution operation to obtain a plurality of feature maps of different scales as high-level feature maps; respectively performing top-down feature fusion and bottom-up feature fusion on each high-level feature map at each scale according to a third convolution operation to correspondingly obtain a plurality of top-down fused feature maps and a plurality of bottom-up fused feature maps; fusing the top-down fused feature maps and the bottom-up fused feature maps to obtain a plurality of bidirectional cross-fused feature maps; and performing disaster and smoke detection on each of the bidirectional cross-fused feature maps. As such, the features of the input image can be more accurately extracted through multiple convolution operations. The top-down fused feature maps and the bottom-up fused feature maps are bidirectionally fused to further acquire more accurate image features, thereby overcoming the problems of insufficient feature extraction and insufficient multi-scale feature fusion in related technologies. Disaster and smoke detection is performed based on the accurate and fully fused features of the bidirectional cross-fused feature maps. Whereby, the accuracy and robustness of detection can be improved, and the problem of poor adaptability of related detection technologies to complex environment can be overcome.

### BRIEF DESCRIPTION OF DRAWINGS

To describe the technical schemes of the embodiments of the present disclosure more clearly, the following briefly introduces the accompanying drawings required for describing the embodiments of the present disclosure. Apparently, the accompanying drawings in the following description show only some embodiments of the present disclosure, and a person of ordinary skill in the art may still derive other drawings from these accompanying drawings without creative efforts.

FIG. 1 is a schematic flowchart of a disaster smoke detection method based on a deep convolutional neural network according to an embodiment of the present disclosure;

FIG. 2 is a detailed flowchart of a disaster smoke detection method based on a deep convolutional neural network according to an embodiment of the present disclosure;

FIG. 3 is a detailed flowchart of operations S1 to S2 in FIG. 2 according to an embodiment of the present disclosure;

FIG. 4 is a detailed flowchart of operation S3 in FIG. 2 according to an embodiment of the present disclosure;

FIG. 5 is a schematic structural diagram of a disaster smoke detection system based on a deep convolutional neural network according to an embodiment of the present disclosure; and

FIG. 6 is a schematic structural diagram of hardware of an electronic device according to an embodiment of the present disclosure.

### DETAILED DESCRIPTION

To make the objectives, technical schemes, and advantages of the present disclosure clearer, the present disclosure is described in further detail with reference to accompanying drawings and embodiments. It should be understood that the specific embodiments described herein are merely used for explaining the present disclosure, and are not intended to limit the present disclosure. When the following descriptions are made with reference to the accompanying drawings, unless otherwise indicated, the same numbers in different accompanying drawings represent the same or similar elements. Implementations described in the following example embodiments do not represent all implementations consistent with the embodiments of the present disclosure, but are merely examples of systems and methods consistent with some aspects of the embodiments of the present disclosure as detailed in the appended claims.

It can be understood that the terms such as “first,” “second,” and the like used in the present disclosure may be used herein to describe various concepts, but these concepts are not limited by these terms unless otherwise specifically stated. These terms are used only to distinguish one concept from another. For example, without departing from the scope of the embodiments of the present disclosure, first information may also be referred to as second information, and similarly, second information may also be referred to as first information. Depending on the context, the terms “if” or “in a case where” as used herein may be construed as “when . . . ,” or “in response to determining”.

For the terms such as “at least one,” “a plurality of,” “each,” “any,” and the like used in the present disclosure, “at least one” includes one, two, or more than two, “a plurality of” includes two or more, “each” refers to each of a plurality of objects, and “any” refers to any of a plurality of objects.

Unless otherwise defined, meanings of all technical and scientific terms used in this specification are the same as those usually understood by a person skilled in the art to which the present disclosure belongs. Terms used in this specification are merely intended to describe objectives of the embodiments of the present disclosure, but are not intended to limit the present disclosure.

Before the embodiments of the present disclosure are described in detail, a description is made on some related technologies involved in the embodiments of the present disclosure.

Flame detection and smoke detection hold significant application value in the fields of fire disaster prevention and safety monitoring. Especially in early fire alarm systems, the rapid and accurate detection of flames and smoke is crucial. At present, conventional detection methods mainly rely on image processing techniques based on low-level features such as color, shape, and motion, and can provide reliable detection results in simple backgrounds. However, when faced with complex backgrounds, significant changes in lighting conditions, or other disturbances, the detection accuracy and robustness of the conventional methods tend to be greatly reduced.

In recent years, with the rapid development of deep learning technologies, especially the widespread application of convolutional neural networks, object detection technologies have made remarkable progress. A detection model based on a deep convolutional neural network exhibits high detection precision and real-time performance in flame detection and smoke detection. Deep convolutional neural network models in related technologies can automatically learn high-level features of flame and smoke, overcoming the dependence of conventional methods on artificial feature extraction, and making the detection process more intelligent and efficient. However, although detection methods based on a deep convolutional neural network have shown certain advantages in flame and smoke detection, there are still many challenges in feature extraction, feature fusion, and adaptability to complex scenarios.

First, flame and smoke have the characteristics of irregular morphology and dynamic changes. Conventional convolutional neural networks often have limitations in extracting the above complex features, and cannot accurately identify objects in complex backgrounds. Second, due to the wide range of scale variation of flame and smoke, existing models often fail to make full use of feature information of different scales when processing features of multiple scales, resulting in unstable detection results. Finally, in low-light and low-contrast scenarios, the detection performance of existing models usually degrades significantly, thereby limiting their ability to support early detection of flames and smoke. Therefore, how to design a method based on a deep convolutional neural network that can extract flame and smoke features more effectively and adapt to complex environments is an urgent problem to be solved at present. The present disclosure aims to improve the accuracy and robustness of flame and smoke detection by improving the feature extraction framework to adapt to application scenarios such as fire warning and safety monitoring.

Therefore, embodiments of the present disclosure provide a disaster smoke detection method and system based on a deep convolutional neural network. The technical scheme of the present disclosure includes: performing a first convolution operation on an input image to extract features to generate a primary feature map; performing enhancement processing on the primary feature map to obtain an enhanced feature map; performing multi-scale fusion on the enhanced feature map according to a second convolution operation to obtain a plurality of feature maps of different scales as high-level feature maps; respectively performing top-down feature fusion and bottom-up feature fusion on each high-level feature map at each scale according to a third convolution operation to correspondingly obtain a plurality of top-down fused feature maps and a plurality of bottom-up fused feature maps; fusing the top-down fused feature maps and the bottom-up fused feature maps to obtain a plurality of bidirectional cross-fused feature maps; and performing disaster and smoke detection on each of the bidirectional cross-fused feature maps. As such, the features of the input image can be more accurately extracted through multiple convolution operations. The top-down fused feature maps and the bottom-up fused feature maps are bidirectionally fused to further acquire more accurate image features, thereby overcoming the problems of insufficient feature extraction and insufficient multi-scale feature fusion in related technologies. Disaster and smoke detection is performed based on the accurate and fully fused features of the bidirectional cross-fused feature maps. Whereby, the accuracy and robustness of detection can be improved, and the problem of poor adaptability of related detection technologies to complex environment can be overcome.

An embodiment of the present disclosure provides a disaster smoke detection method based on a deep convolutional neural network, relating to the technical field of image processing. The disaster smoke detection method based on a deep convolutional neural network according to the embodiments of the present disclosure may be applied to a terminal or a server, or may be software running in a terminal or a server. In some embodiments, the terminal may be a smartphone, a tablet computer, a notebook computer, a desktop computer, a smart speaker, a smartwatch, an in-vehicle terminal, and the like, but is not limited thereto. The server may be configured as an independent physical server, or may be configured as a server cluster or distributed system including a plurality of physical servers, or may be configured as a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The server may also be a node server in a blockchain network. The software may be an application for implementing the disaster smoke detection method based on a deep convolutional neural network, etc. However, the present disclosure is not limited to the above forms.

The present disclosure may be used in a wide variety of general purpose or special purpose computer system environments or configurations, for example, personal computers (PCs), server computers, handheld or portable devices, tablet-type devices, multiprocessor systems, microprocessor-based systems, set-top boxes, programmable consumer electronic devices, network PCs, midrange computers, mainframe computers, distributed computing environments including any of the above systems or devices, etc. The present disclosure may be described in the general context of computer-executable instructions executed by a computer, for example, program modules. Generally, the program modules include routines, programs, objects, components, data structures, and the like for performing specific tasks or implementing specific abstract data types. The present disclosure may also be practiced in distributed computing environments in which tasks are performed by remote processing devices connected through a communication network. In a distributed computing environment, program modules may be located in local and remote computer storage media, including storage devices.

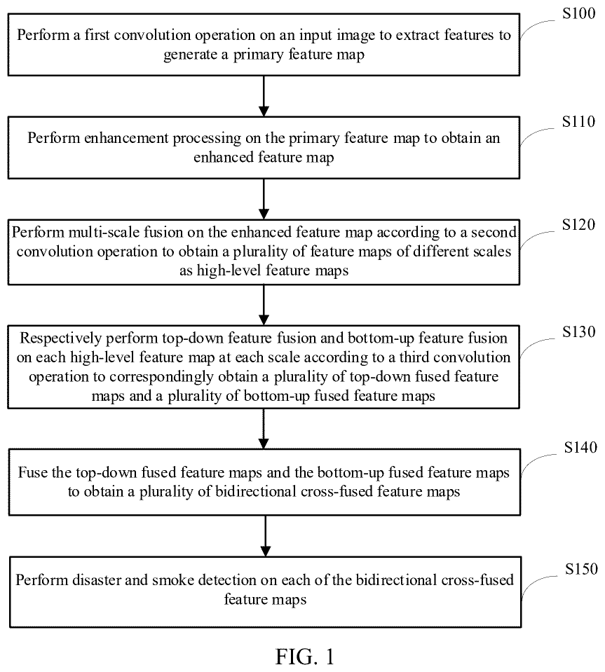

Referring to FIG. 1, an embodiment of the present disclosure provides a disaster smoke detection method based on a deep convolutional neural network. The method may include, but is not limited to, the following steps $100 to S150.

At S100, a first convolution operation is performed on an input image to extract features to generate a primary feature map.

It can be understood that the input image in this embodiment may be any image. To achieve efficient disaster and smoke detection, in this embodiment, an image of an outdoor or indoor key region where fire is prone to occur may be used as the input image. For example, a monitoring device may be used to acquire an image of the key region as the input image in real time.

Further, S100 may include the following steps S101 to S102.

At S101, a convolution operation is performed on the input image through a spatial and channel reconstruction convolution module to obtain a basic feature map,
where the convolution operation of the spatial and channel reconstruction convolution module is expressed as the following formula:

$${X}^{′} = ScConv ( X ) = {σ}_{act} ( BN ( CRU ( SRU ( Conv ( X ) ) ) ) ) ,$$

where X′ represents the basic feature map; ScConv represents a spatial and channel reconstruction convolution operation; Conv(X) represents a convolution operation of the input image X with a weight W, with a kernel size of k×k and a stride s, using automatic padding p to adjust a size of a feature map to be outputted; SRU(X) is used for handling spatial redundancy; CRU(X) is used for handling channel redundancy; BN(·) represents a batch normalization operation; and σ_{act}(·) represents an activation function.

At S102, a convolution operation is performed on the basic feature map through a residual block to obtain the primary feature map,
where the convolution operation of the residual block is expressed as the following formula:

$$F ( {X}^{′} ) = {ScConv}_{2} ( {σ}_{act} ( {BN}_{1} ( {ScConv}_{1} ( {X}^{′} ) ) ) ) ;$$

and
residual connection of the residual block is expressed as the following formula:

$${Y}^{′} = {X}^{′} + F ( {X}^{′} ) ,$$

where ScConv₁ and ScConv₂ represent two consecutive spatial and channel reconstruction convolution operations, F(X′) represents a convolved feature mapping, and Y′ the primary feature map.

At S110, enhancement processing is performed on the primary feature map to obtain an enhanced feature map.

In this embodiment, enhancement processing may be performed on the primary feature map to extract higher-level features with richer information.

Further, S110 may include the following steps S111 to S114.

At S111, a weight matrix corresponding to the primary feature map is generated through a convolution operation of an attention mechanism, and element-wise multiplication is performed on the weight matrix and the primary feature map to obtain a first intermediate feature map,
where the convolution operation of the attention mechanism is expressed as the following formula:

$$A = Sigmoid ( {Conv}_{a t t} ( {Y}^{′} ) ) ,$$

where A represents the weight matrix, Convₐₜₜ represents the convolution operation that generates the weight matrix, and Sigmoid represents a function for generating a normalized output; and the first intermediate feature map is defined as Z′, and Z′=A⊙Y′.

At S112, an offset amount of a deformable convolutional layer of the first intermediate feature map is generated through a local convolution operation, and a deformable convolution operation is performed according to the offset amount of the deformable convolutional layer and the first intermediate feature map to obtain a second intermediate feature map,
where the offset amount of the deformable convolutional layer is expressed as the following formula:

$$Δ p = C o n {v}_{offset} ( {Z}^{′} ) ;$$

and
where the deformable convolution operation is expressed as the following formula:

$${Z}^{″} = DeformConv ( {Z}^{′} , Δ p ) ,$$

where Δp represents the offset amount of the deformable convolutional layer, Conv_{offset} represents a convolution operation of an independent convolutional layer, DeformConv represents the deformable convolution operation, and Z″ represents the second intermediate feature map.

At S113, Gabor filtering processing is performed on the second intermediate feature map to obtain a filtered feature map,
where the Gabor filtering processing is expressed as the following formula:

$$G ( x , y ) = exp ( - \frac{{x}^{2} + {γ}^{2} {y}^{2}}{2 {{σ}_{gabor}}^{2}} ) cos ( 2 π \frac{x}{λ} + ψ ) ,$$

where σ_{gabor} is used for controlling a width of a Gaussian function, γ is used for controlling an aspect ratio of an elliptical Gaussian distribution, λ represents a wavelength, ψ represents a phase offset, and x, y represents pixel coordinates.

At S114, a brightness and contrast of the filtered feature map is adjusted to obtain the enhanced feature map.

At S120, multi-scale fusion is performed on the enhanced feature map according to a second convolution operation to obtain a plurality of feature maps of different scales as high-level feature maps.

Specifically, a convolution operation is performed on the enhanced feature map to generate a plurality of images of different scales, and the plurality of images are fused to obtain high-level feature maps.

Further, S120 may include the following steps S121 to S123.

At S121, maximum pooling operations of different scales are performed on the enhanced feature map to obtain a plurality of maximum pooled feature maps.

At S122, the maximum pooled feature maps are spliced to obtain a spliced feature map, and the spliced feature map is inputted to a target convolutional layer for fusion to obtain a multi-scale feature map.

At S123, a feature of a target region in the multi-scale feature map is enhanced through an attention mechanism to obtain the high-level feature maps.

At S130, top-down feature fusion and bottom-up feature fusion are respectively performed on each high-level feature map at each scale according to a third convolution operation to correspondingly obtain a plurality of top-down fused feature maps and a plurality of bottom-up fused feature maps.

It can be understood that the high-level feature maps of different scales may be sorted by scale, and then subjected to top-down feature fusion and bottom-up feature fusion, respectively.

Further, S130 may include the following steps S131 to S134.

At S131, a number of channels of each of the high-level feature maps are converted to a consistent dimension through a 1×1 convolution operation to obtain a plurality of converted feature maps.

At S132, starting from the converted feature map of a highest layer of the scale, the converted feature maps are propagated downward layer by layer through interpolation upsampling, and weighted fusion is performed with the converted feature map of a next layer to obtain a first fused feature map,
where the first fused feature map is expressed as the following formula:

$${P}_{i}^{TD} = {α}_{i , 1} \cdot {P}_{i} + {α}_{i , 2} \cdot Up ( {\tilde{P}}_{i + 1}^{T D} ) ,$$

where

$${P}_{i}^{TD}$$

represents the first fused feature map, Pᵢ represents the converted feature map, Up(·) represents an upsampling operation,

$${\tilde{P}}_{i + 1}^{TD}$$

represents a feature map obtained by depthwise separable convolution, α_{i,1} and α_{i,2} represent learnable first fusion weights, and the first fusion weights are constrained to be non-negative by a ReLU function.

At S133, starting from the converted feature map of a lowest layer of the scale, the converted feature maps are propagated upward layer by layer through downsampling, and weighted fusion is performed with the converted feature map of a previous layer to obtain a second fused feature map,
where the second fused feature map is expressed as the following formula:

$${P}_{i}^{BU} = {β}_{i , 1} \cdot {P}_{i}^{TD} + {β}_{i , 2} \cdot {\tilde{P}}_{i} + {β}_{i , 3} \cdot Down ( {P}_{i - 1}^{BU} ) ,$$

where

$${P}_{i}^{BU}$$

represents the second fused feature map, Down(·) represents a downsampling operation, \tilde{P}ᵢ represents a feature map obtained by depthwise separable convolution, and β_{i,1}, β_{i,2}, and β_{i,3} represent learnable second fusion weights.

At S134, the first fusion weights and the second fusion weights are adjusted according to a minimization loss function through a back propagation algorithm, the top-down fused feature maps are generated using the adjusted first fusion weights, and the bottom-up fused feature maps are generated using the adjusted second fusion weights,
where the minimization loss function is expressed as the following formula:

$$L = {\sum }_{i = 2}^{6} {L}_{task} ( {F}_{i}^{TD} , {F}_{i}^{BU} ) ;$$

where the top-down fused feature map is expressed as the following formula:

$${F}_{i}^{TD} = {α}_{i , 1} \cdot {P}_{i}^{TD} + {α}_{i , 2} \cdot Up ( {F}_{i + 1}^{TD} ) ;$$

and
where the bottom-up fused feature map is expressed as the following formula:

$${F}_{i}^{BU} = {β}_{i , 1} \cdot {P}_{i}^{BU} + {β}_{i , 2} \cdot {P}_{i} + {β}_{i , 3} \cdot Down ( {F}_{i - 1}^{BU} ) ,$$

where L represents the minimization loss function,

$${F}_{i}^{TD}$$

represents the top-down fused feature map,

$${F}_{i}^{BU}$$

represents the bottom-up fused feature map, and i represents a hierarchical sequence number of the converted feature map.

At S140, the top-down fused feature maps and the bottom-up fused feature maps are fused to obtain a plurality of bidirectional cross-fused feature maps.

Specifically, the top-down fused feature maps and the bottom-up fused feature maps are bidirectionally cross-fused to fully integrate features of the input features.

Further, S140 may include the following steps S141 to S142.

At S141, an optimized fusion weight is determined according to the adjusted first fusion weights and the adjusted second fusion weights.

At S142, the top-down fused feature maps and the bottom-up fused feature maps are fused according to the optimized fusion weight to obtain the plurality of the bi-directional cross-fused feature maps,
where the bidirectional cross-fused feature map is expressed as the following formula:

$${F}_{i} = {\sum }_{i = 2}^{6} {γ}_{i} \cdot ( {F}_{i}^{TD} + {F}_{i}^{BU} ) ,$$

where Fᵢ represents the bidirectional cross-fused feature map, and γᵢ represents the optimized fusion weight.

At S150, disaster and smoke detection is performed on each of the bidirectional cross-fused feature maps.

Specifically, in this embodiment, object detection may be performed on each of the bidirectional cross-fused feature maps that fully integrates features of various scales to detect disasters and smoke in the bidirectional cross-fused feature maps.

Further, S150 may include the following steps S151 to S154.

At S151, categories of objects in each of the bidirectional cross-fused feature maps are identified through a classification convolution operation to obtain a classification result, where the objects include the disaster and smoke; and
the classification result is expressed as the following formula:

$${F}_{i , cls} = {σ}_{cls} ( BN ( {Conv}_{cls} ( {F}_{i} ) ) ) ,$$

where F_{i,cls} represents the classification result, Conv_{cls} represents the classification convolution operation, BN(·) represents a batch normalization operation, σ_{cls}(·) represents an activation function of classification convolution, and Fᵢ represents the bidirectional cross-fused feature map.

At S152, a probability of each of the objects is determined according to the classification result and a confidence level of each of the probabilities is generated,
where a probability distribution of each of the objects is expressed as the following formula:

$$P ( C \vert {F}_{i} ) = Soft max ( {F}_{i , cls} ) ,$$

where P(C|Fᵢ) represents the probability distribution, C represents the probability, and Softmax represents an activation function.

At S153, a bounding box parameter for each of the objects in each of the bidirectional cross-fused feature maps is outputted through a regression convolution operation,
where the bounding box parameter is expressed as the following formula:

$$B ( {F}_{i} ) = {Conv}_{reg} ( {F}_{i} ) ,$$

where B(Fᵢ) represents the bounding box parameter, and Conv_{reg} represents the regression convolution operation.

At S154, the probability of each of the objects, the confidence level of each of the probabilities, and the bounding box parameter of each of the targets are determined as a detection result of the disaster and smoke detection,
where the detection result is expressed as the following formula:

$${O}_{i} = \{ ( C , S ( C \vert {F}_{i} ) , B ( {F}_{i} ) ) \} ,$$

where Oᵢ represents the detection result, and S(C|Fᵢ) represents the confidence level.

To further improve the accuracy of a bounding box, in an embodiment of the present disclosure, the method may further include the following steps S155 to S156.

At S155, the bounding box parameter is optimized using a distributed focal loss to obtain an optimized bounding box parameter,
where the optimized bounding box parameter is expressed as the following formula:

$${B}^{′} ( {F}_{i} ) = DFL ( B ( {F}_{i} ) ) ,$$

where B′(Fᵢ) represents the optimized bounding box parameter, and DFL represents the distributed focal loss.

At S156, the detection result is updated according to the optimized bounding box parameter,
where the updated detection result is expressed as the following formula:

$${O}_{i} = \{ ( C , S ( C \vert {F}_{i} ) , {B}^{′} ( {F}_{i} ) ) \} .$$

An objective of the distributed focal loss is to generate a more accurately localized bounding box by modeling the distribution of the bounding box.

Next, the schemes of the embodiments of the present disclosure will be described in detail in conjunction with specific application examples.

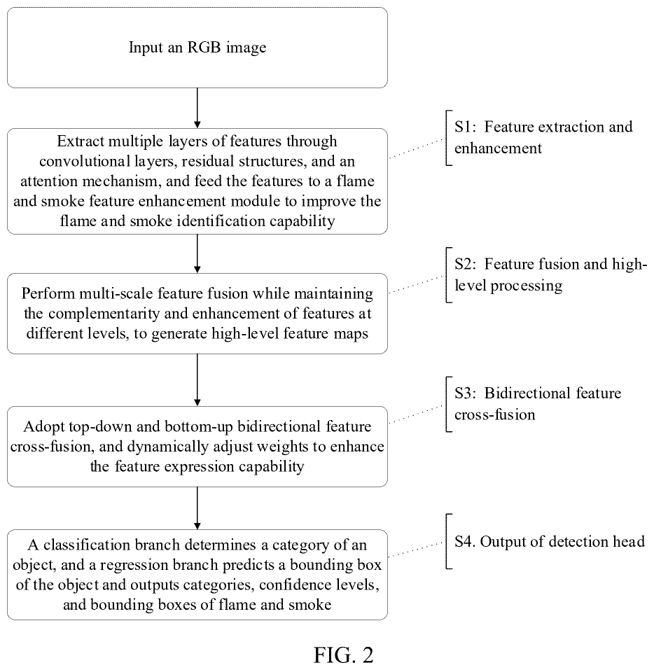

Referring to FIG. 2, this embodiment may include the following steps S1 to S4.

S1. Feature extraction and enhancement: Preliminary feature extraction is performed on an input image to generate a basic feature map. Further, primary features are extracted through multiple convolutional layers, residual structures, and an attention mechanism, and fed to a flame and smoke feature enhancement module to improve the flame and smoke identification capability of the primary feature map to obtain an enhanced feature map, thus capturing the shape and complex pattern of an object.

S2. Feature fusion and high-level processing: Through a deeper convolution layer and a feature fusion module, multi-scale fusion is performed on enhanced features of different scales, while maintaining the complementarity and enhancement of features at different levels. Finally, the enhanced feature map is further processed to output a plurality of high-level feature maps to be passed into a bidirectional feature cross-fusion module.

S3. Bidirectional feature cross-fusion: The bidirectional feature cross-fusion module receives a multi-scale feature map (i.e., high-level feature maps) from a backbone network, adopts top-down and bottom-up bidirectional feature cross-fusion structures, and dynamically adjusts weight parameters to obtain bidirectional cross-fused feature maps, thus enhancing the expression capability of the high-level feature maps and providing a more expressive feature representation for subsequent detection tasks.

S4. Classification and regression output of detection head: A detection head module processes the multi-scale feature map (i.e., the bidirectional cross-fused feature maps) passed by the bidirectional feature cross-fusion module, and divides the multi-scale feature map into a classification branch and a regression branch. The classification branch is used for determining a category of an object, and the regression branch is used for predicting a position and size of a bounding box of the object. Finally, the classification and regression results are integrated to output the category, a confidence level, and the bounding box of the object for flame and smoke detection tasks.

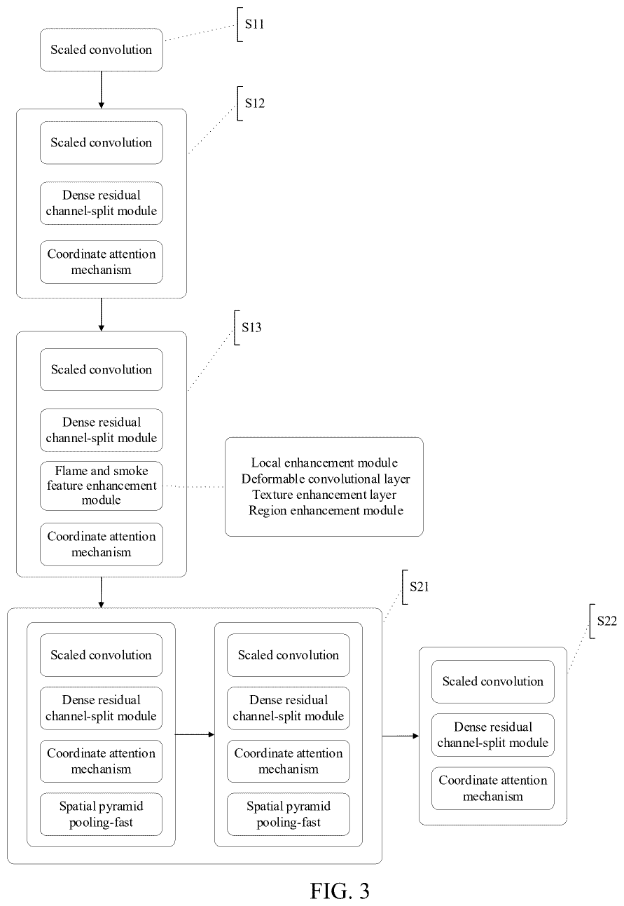

FIG. 3 is a detailed flowchart of operations S1 to S2 according to an embodiment of the present disclosure.

In the feature extraction and enhancement stage of S1, a preliminary feature extraction module first extracts low-level features from the input image, and performs a convolution operation on the low-level features to generate the basic feature map. The basic feature map mainly captures basic edge and simple shape information in the image. Based on this, the network can construct a preliminary understanding of the image from the most primitive pixel level. To further improve the capability of identifying an object such as flame and smoke, multiple convolutional layers and residual structures are then introduced in the system to gradually extract intermediate features which are more complex. The residual structures alleviate the vanishing gradient problem, which is caused by the increase of network depth, through the use of skip connections, thereby ensuring that the network can learn valid intermediate features. In this process, the attention mechanism is used for dynamically adjusting the importance of different regions in the feature map, allowing the network to pay more attention to key regions such as flames and smoke. In addition, the feature enhancement module is specially optimized for unique features of flame and smoke to further improve the capability to express high-level features, so that the network can still accurately identify the shapes and complex patterns of flame and smoke in complex backgrounds. Specifically, S1 includes the following steps S11 to S13.

At S11, in a preliminary feature extraction stage of a flame and smoke feature detection task, basic features are extracted from the input image. The input image X is expressed as a four-dimensional tensor X∈ [symbol] , where N represents a batch size, H represents an image height, W represents an image width, and C represents the number of channels. The input image is first convolved through the spatial and channel reconstruction convolution module. The spatial and channel reconstruction convolution module includes a spatial redundancy suppression unit (SRU) and a channel redundancy suppression unit (CRU), which are used for handling spatial redundancy and channel redundancy simultaneously. The convolution operation of the spatial and channel reconstruction convolution module is expressed as the following formula:

$${X}^{′} = ScConv ( X ) = σ ( BN ( CRU ( SRU ( Conv ( X ) ) ) ) ) ,$$

where Conv(X) represents a convolution operation of the input image X with a weight W, with a kernel size of k×k and a stride s, using automatic padding p to determine a size of a feature map to be outputted, SRU(X) is used for handling spatial redundancy, and CRU(X) is used for handling channel redundancy. BN(X) represents a group batch normalization operation, and σ(X) represents a SiLU activation function. The basic feature map generated through this operation is X′∈ [symbol] , where

$${H}^{′} = \frac{H}{2} , {W}^{′} = \frac{w}{2} ,$$

which indicates that the resolution of the input image is halved after the preliminary feature extraction, while retaining low-level feature information, such as edges and simple shapes.

At S12, in a further feature extraction stage, the basic feature map X′ is further inputted to a Dark2 module, which includes multiple spatial and channel reconstruction convolution layers and residual structures to extract more intermediate features. These features can better represent complex textures, edge combinations, and local patterns.

The core idea of the residual structures is to alleviate the common vanishing gradient problem in deep neural networks by adding the input directly to the output of the convolutional layer via a skip connection. The convolution operation of the residual block may be expressed as the following formula:

$$F ( {X}^{′} ) = S c C o n {v}_{2} ( σ ( B {N}_{1} ( S c C o n {v}_{1} ( {X}^{′} ) ) ) ) .$$

The residual connection may be expressed as the following formula:

$${Y}^{′} = {X}^{′} + F ( {X}^{′} ) ,$$

where ScConv₁ and ScConv₂ are two consecutive spatial and channel reconstruction convolution operations, and F(X′) represents a convolved feature mapping, which is further optimized by the SRU and CRU modules. Through residual connection, the network can keep the passing of input information, ensuring that important information in the feature map will not be lost or weakened due to multiple convolution operations.

In addition, a coordinate attention mechanism is also introduced in this embodiment. The core of the attention mechanism is to generate a weight matrix A, which is used for adjusting the importance of each feature channel, thereby enhancing the attention of the network to a key region. A specific calculation operation of the attention mechanism is expressed as the following formula:

$$A = Sigmoid ( {Conv}_{a t t} ( {Y}^{′} ) ) ,$$

where Convₐₜₜ represents a convolutional layer that generates an attention weight, and Sigmoid represents a function for normalizing an output to a range of [0, 1]. Element-wise multiplication is performed on the obtained weight matrix A and the primary feature map Y′ to obtain an enhanced feature map, i.e., a first intermediate feature map Z′=A⊙Y′. An expression of features of an important region in the image can be better captured through this operation.

At S13, in a still further feature extraction stage, a flame and smoke feature enhancement module is introduced to further improve the sensitivity of the network to flame and smoke features. First, the first intermediate feature map is enhanced through a local convolution operation to improve the expression capability of local information of the first intermediate feature map. Next, a geometric variation of the first intermediate feature map is captured through a deformable convolution. An offset amount Δp of a deformable convolutional layer is generated by an independent convolutional layer:

$$Δ p = C o n {v}_{offset} ( {Z}^{′} ) .$$

Then, a second intermediate feature map is generated through a deformable convolution operation:

$${Z}^{″} = DeformConv ( {Z}^{′} , Δ p ) .$$

In addition, to better identify flame and smoke features, the module also introduces a Gabor filter layer, which is used for filtering noise in the second intermediate feature map to extract texture information and obtain a filtered feature map. Gabor filtering is mathematically expressed as the following formula:

$$G ( x , y ) = exp ( - \frac{{x}^{2} + {γ}^{2} {y}^{2}}{2 {σ}^{2}} ) cos ( 2 π \frac{x}{λ} + ψ ) ,$$

where the parameter σ is used for controlling a width of a Gaussian function, γ is used for controlling an aspect ratio of an elliptical Gaussian distribution, λ represents a wavelength, ψ represents a phase offset, and x, y represents pixel coordinates. The filter can effectively extract directional texture features in the image, thereby enhancing the detectability of flame and smoke.

A brightness and contrast of the filtered feature map are further adjusted through a brightness mask layer and a contrast enhancement layer, to make the flame and smoke features more prominent, and finally obtain an enhanced feature map Y∈ [symbol] that can be better used for subsequent detection tasks.

In the feature fusion and high-level processing stage of S2, first, the hierarchy of the enhanced feature map is further exploited through a deeper convolution layer. The multi-scale feature fusion module plays a key role in this stage, i.e., effectively integrates feature maps of different scales, to ensure that the network has higher flexibility in dealing with the diversity and complexity of flame and smoke. Specifically, the feature fusion module fuses the feature maps of different scales at multiple levels through spatial pooling and convolution operations, so that low-level details information and high-level semantic information can complement each other. This multi-scale fusion not only retains the feature information at all levels, but also further enhances the expression capability of the feature map and improves the robustness of the overall feature map. After this stage of processing, the outputted high-level feature maps not only contain rich semantic information, but also have higher spatial resolution and identification capability, laying a solid foundation for the subsequent processing of the bidirectional feature cross-fusion module. Specifically, S2 includes the following steps S21 to S22.

At S21, the network further extracts high-level features through a deeper convolution layer and a feature fusion module to capture information of more scales. Multi-scale fusion is performed on the feature maps through maximum pooling operations at different scales. Specific operations are expressed as follows:

$${Y}_{1} = {MaxPool}_{k = 5} ( Y ) , {Y}_{2} = {MaxPool}_{k = 9} ( {Y}_{1} ) , {Y}_{3} = {MaxPool}_{k = 13} ( {Y}_{2} ) .$$

The multi-scale feature maps Y₁, Y₂, and Y₃ are spliced together, and are then inputted into a final convolutional layer for fusion to output a multi-scale feature map Z∈ [symbol] . This operation can effectively fuse the features of different scales, providing a more expressive feature representation for subsequent detection modules.

At S22, a coordinate attention mechanism is introduced to enhance feature selectivity. Through the attention mechanism, the network can better identify and enlarge features of target regions such as flame and smoke in the multi-scale feature map. The finally outputted high-level feature map is expressed as Zᵢ∈ [symbol] , which is passed to the subsequent bidirectional feature cross-fusion module for further object detection.

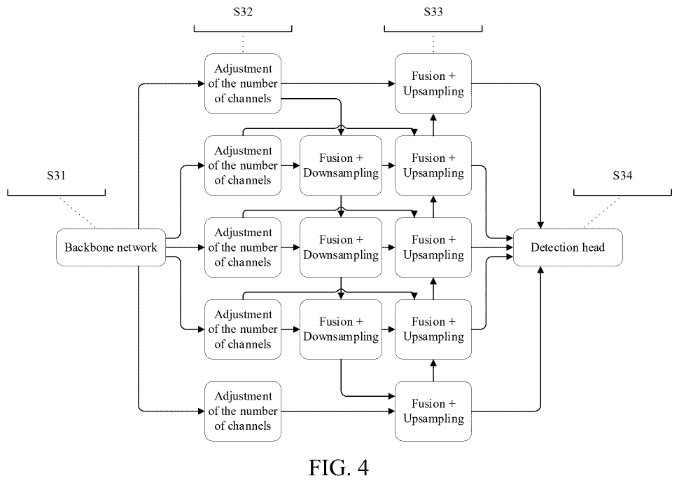

FIG. 4 is a detailed flowchart of operation S3 according to an embodiment of the present disclosure.

In the bidirectional feature cross-fusion stage of S3, a bidirectional feature cross-fusion module is adopted, which transitions from multi-scale fusion of feature maps to the processing stage of bidirectional fusion. The bidirectional feature cross-fusion module passes high-level semantic information to lower-level feature maps layer by layer through a top-down feature propagation path, so that the feature map of each scale contains rich semantic information. In addition, the bidirectional feature cross-fusion module integrates low-level spatial details into the high-level feature maps layer by layer through a bottom-up feature convergence path, to enhance the spatial detail expression capability of the feature maps. Through the dynamic interaction of these two fusion paths, the bidirectional feature cross-fusion module can effectively adjust the weight assignment for each layer of feature maps in the fusion process, so that the contributions of the feature maps of different scales during fusion reach an optimal state. Through such a dynamic weight adjustment mechanism, the bidirectional feature cross-fusion module not only ensures the diversity and expression capability of feature maps, but also significantly improves the stability and precision of features, providing more accurate and multi-dimensional feature representation for subsequent detection tasks. Specifically, S3 includes the following steps S31 to S34.

At S31, in an initial stage, the bidirectional feature cross-fusion module first receives the multi-scale feature map, i.e., the high-level feature maps Zᵢ, from the backbone network, where Zᵢ∈ [symbol] , i representing feature maps extracted by different deep network layers. Each high-level feature map contains information ranging from low-level edges and textures to high-level complex semantic information. For example, a low-level feature Z₁ captures basic information such as edges and textures in the input image, and a high-level feature Zₙ contains more complex semantic information such as the morphology and structure of flame and smoke. To unify feature representations of different scales, the bidirectional feature cross-fusion module first converts a number of channels of each of the high-level feature maps to a consistent dimension through a 1×1 convolution operation to obtain converted feature maps, thereby reducing the computational complexity and enhancing the fusion effect. This process may be expressed as:

$${P}_{i} = C o n {v}_{1 \times 1} ( {Z}_{i} ) , where {P}_{i} ∈ ,$$

where Pᵢ represents the converted feature map, and C′ represents the number of channels after the unification. This operation lays a foundation for the subsequent bidirectional feature cross-fusion.

At S32, the bidirectional feature cross-fusion module effectively combines the converted feature maps of different scales according to a top-down fusion policy and a bottom-up fusion policy. In the top-down path, starting from a feature map P₆ of the highest layer, the bidirectional feature cross-fusion module propagates the converted feature maps downward layer by layer through interpolation upsampling, and performs weighted fusion with converted feature maps of a next layer, i.e., P₅, P₄, . . . , P₂, to obtain a first fused feature map. The weighted feature fusion is expressed as the following formula:

$${P}_{i}^{TD} = {α}_{i , 1} \cdot {P}_{i} + {α}_{i , 2} \cdot Up ( {\tilde{P}}_{i + 1}^{TD} ) ,$$

where

$${P}_{i}^{TD}$$

represents the first fused feature map, Up(·) represents an upsampling operation,

$${\tilde{P}}_{i + 1}^{TD}$$

represents a feature map obtained by depthwise separable convolution, α_{i,1} and α_{i,2} represent learnable first fusion weights, and the first fusion weights are constrained to be non-negative by a ReLU function to improve the stability of feature fusion.

In the bottom-up path, starting from a converted feature map

$${P}_{2}^{TD}$$

of the lowest layer, the bidirectional feature cross-fusion module propagates the converted feature maps upward layer by layer through downsampling, and performs weighted fusion with converted feature maps of a previous layer, i.e.,

$${P}_{3}^{TD} , {P}_{4}^{TD} , … , {P}_{6}^{TD} ,$$

to obtain a second fused feature map. The weighted feature fusion is expressed as the following formula:

$${P}_{i}^{BU} = {β}_{i , 1} \cdot {P}_{i}^{TD} + {β}_{i , 2} \cdot {\tilde{P}}_{i} + {β}_{i , 3} \cdot Down ( {P}_{i - 1}^{BU} ) ,$$

where

$${P}_{i}^{BU}$$

represents the second fused feature map, Down(·) represents a downsampling operation, \tilde{P}ᵢ represents a feature map obtained by depthwise separable convolution, and β_{i,1}, β_{i,2}, and β_{i,3} represent learnable second fusion weights.

The bidirectional fusion structures in this embodiment enable the information of the converted feature maps on multiple scales to complement and enhance each other. As such, the bi-directional feature cross-fusion module can synthesize information at different scales, thereby achieving more efficient fusion of features of multiple scales.

At S33, in the feature fusion process, to better balance the contribution of the features of different scales, the bidirectional feature cross-fusion module introduces a dynamic weight adjustment mechanism. In this mechanism, learnable fusion weights αᵢ and βᵢ are set to enable the network to automatically adjust the fusion weights of the feature maps according to a specific task requirement during training. An objective of the fusion weight adjustment is to optimize the results of feature fusion, so that the contribution of each feature map during fusion reaches an optimal state, thereby maximizing the expression capability of the feature maps. For the fusion in the top-down path, the feature map outputted after the fusion weight adjustment is a top-down fused feature map

$${F}_{i}^{BU} ,$$

where:

$${F}_{i}^{TD} = {α}_{i , 1} \cdot {P}_{i}^{TD} + {α}_{i , 2} \cdot Up ( {F}_{i + 1}^{TD} ) .$$

For the fusion in the bottom-up path, the feature map outputted after the fusion weight adjustment is a bottom-up fused feature map

$${F}_{i}^{BU} ,$$

where:

$${F}_{i}^{BU} = {β}_{i , 1} \cdot {P}_{i}^{BU} + {β}_{i , 2} \cdot {P}_{i} + {β}_{i , 3} \cdot Down ( {F}_{i - 1}^{BU} ) .$$

The fusion weights may be optimized through a back propagation algorithm using a minimization loss function L as a constraint during training of the backbone network:

$$L = {\sum }_{i = 2}^{6} {L}_{task} ( {F}_{i}^{TD} , {F}_{i}^{BU} ) .$$

During the training process, the fusion weights αᵢ and βᵢ are continuously adjusted to make the contribution of each fused feature map reach an optimal state during fusion, thereby improving the overall feature expression capability.

At S34, the feature maps processed by the bidirectional feature cross-fusion and the dynamic weight adjustment are integrated in the bidirectional feature cross-fusion module to obtain bidirectional cross-fused feature maps, which are denoted as Fᵢ. The bidirectional cross-fused feature map combines the advantages of features of different scales and has a stronger expression capability. The bidirectional cross-fused feature map may be expressed as the following formula:

$${F}_{i} = {\sum }_{i = 2}^{6} {γ}_{i} \cdot ( {F}_{i}^{TD} + {F}_{i}^{BU} ) ,$$

where γᵢ represents a further optimized fusion weight, which is used to fully fuse and enhance the features of different scales. The bidirectional cross-fused feature map Fᵢ not only combines the advantages of features of different scale, but also has a stronger expression capability, to more effectively support a flame and smoke detection task of an object detection head. The feature maps obtained by the processing in this embodiment are particularly suitable for detection in complex scenarios and detection for objects of multiple scales, and can significantly improve the accuracy and robustness of detection.

In the classification and regression output stage of the detection head in S4, the bidirectional cross-fused feature maps are received from the bidirectional feature cross-fusion module, and the bidirectional cross-fused feature maps are respectively fed to the classification branch and the regression branch that are in parallel with each other. The classification branch first processes the bidirectional cross-fused feature maps through a series of convolutional layers to extract information related to a category of an object, and then outputs a distribution of probabilities of categories through a Softmax activation function, to determine a category attribute of the object. Meanwhile, the regression branch focuses on spatial localization of the object, i.e., extracts bounding box information of the object through a convolutional layer and predicts the location, width, and height of the object. To improve the effectiveness of the classification and regression task, an optimized loss function may be used in this embodiment, which is specially designed especially for scenarios of small-object detection in a complex background. Finally, the detection head module integrates the results of the classification branch and the regression branch to output category, confidence level, and bounding box information of each object. Through the above integration process, an accurate and reliable detection result can be provided in a complex flame and smoke detection task, thereby improving the performance in application scenarios such as fire warning and safety monitoring. Specifically, S4 includes the following steps S41 to S44.

At S41, the operation of the detection head module begins with receiving the bidirectional cross-fused feature maps Fᵢ from the bidirectional feature cross-fusion module, where i represents a scale level of the bidirectional cross-fused feature map. The bidirectional cross-fused feature map Fᵢ∈ [symbol] contains feature information of flame and smoke objects extracted at different scales. With the design of different scale levels, the detection head can capture information of flame and smoke objects at different granularities, ranging from details to a global view. The diversity and richness of bidirectional cross-fused feature maps ensure that the subsequent classification and regression task can be performed with a high-quality input, thereby achieving high-precision object detection.

At S42, after receiving the bidirectional cross-fused feature maps, the detection head module further processes the bidirectional cross-fused feature maps through a series of convolution operations and divides the bidirectional cross-fused feature maps into two parallel branches: a classification branch and a regression branch. The classification branch is responsible for determining a probability P(C|Fᵢ) of a category of an object, where P(C|Fᵢ) represents a probability of a category C on the bidirectional cross-fused feature map Fᵢ. The regression branch focuses on predicting a bounding box parameter B(Fᵢ) of the object, including center coordinates, width, and height of the object. In each branch, multiple layers of convolution operations are performed on each of the bidirectional cross-fused feature maps to gradually extract key information for classification and localization. Specifically, the operation of the classification branch may be expressed as the following formula:

$${F}_{l , cls} = σ ( BN ( Con {v}_{cls} ( {F}_{i} ) ) ) ,$$

where Conv_{cls} represents a classification convolution operation, BN represents a batch normalization layer, and σ represents an activation function, such as SiLU or ReLU. The classification result is processed by Softmax to obtain a distribution of probabilities of categories:

$$P ( C \vert {F}_{i} ) = Softmax ( {F}_{i , cls} ) .$$

The regression branch outputs a regression parameter B(Fᵢ) of the bounding box through a convolution layer:

$$B ( {F}_{i} ) = {Conv}_{reg} ( {F}_{i} ) .$$

At S43, in the classification branch, the detection head calculates a score P(C|Fᵢ) of each category of an object on each bidirectional cross-fused feature map Fᵢ through a plurality of convolutional layers. An objective of this process is to output a probability distribution that each position on the bidirectional cross-fused feature map belongs to a category C. The probability distribution plays a key role in the subsequent non-maximum suppression processing. Meanwhile, in the regression branch, the detection head further refines the predicted bounding box parameter using a distributed focal loss. An objective of the distributed focal loss is to generate a more accurate localization result by modeling the distribution of bounding boxes. The distributed focal loss processes the regression result:

$${B}^{′} ( {F}_{i} ) = DFL ( B ( {F}_{i} ) ) ,$$

where B′(Fᵢ) represents the bounding box parameter obtained through processing by the distributed focal loss. The distributed focal loss performs weighted summation on the distribution of bounding box parameters to generate a final prediction result.

At S44, the detection head module integrates the results of the classification branch and the regression branch. For each bidirectional cross-fused feature map Fᵢ, the final output includes the category C and the confidence level S(C|Fᵢ) of the object, and the bounding box B′(Fᵢ) obtained through processing by the distributed focal loss. The integrated detection result may be expressed as the following formula:

$${O}_{i} = \{ ( C , S ( C \vert {F}_{i} ) , {B}^{′} ( {F}_{i} ) ) \} ,$$

where Oᵢ represents the detection result on the bidirectional cross-fused feature map Fᵢ, including the category, confidence level, and bounding box coordinates of each object being detected. The detection result plays an important role in the final detection task, including the precise localization and classification of flame and smoke objects. Overlapping detection boxes may be further filtered out through post-processing operations such as non-maximum suppression, to retain the most likely object position.

By combining the features of multiple scales and performing the deep multi-layer convolution processing, the detection head module can capture the diversity of objects, and improve the precision of small-object detection in a complex background through efficient classification and localization policies. Embodiments of the present disclosure have high robustness and accuracy in practical applications, especially in scenarios such as fire warning and safety monitoring, and can effectively cope with changing environments and complex scenarios.

Embodiments of the present disclosure have the following beneficial effects.

The introduction of the deep convolutional neural network and the bidirectional feature cross-fusion module effectively improves the accuracy and robustness of flame detection and smoke detection. With the use of the improved backbone network structure and the specially designed flame and smoke feature enhancement module, features of multiple scales can be extracted more accurately, thereby achieving effective flame and smoke identification in complex scenarios. With the use of the dynamic weight adjustment mechanism and the bidirectional feature cross-fusion policy in the bidirectional feature cross-fusion module, the expression capability of multi-layer feature maps is further optimized, thereby significantly improving the capability of detecting a small object and dealing with a complex background. Finally, the optimized detection head design exhibits an excellent detection result in practical application scenarios such as fire warning and safety monitoring.

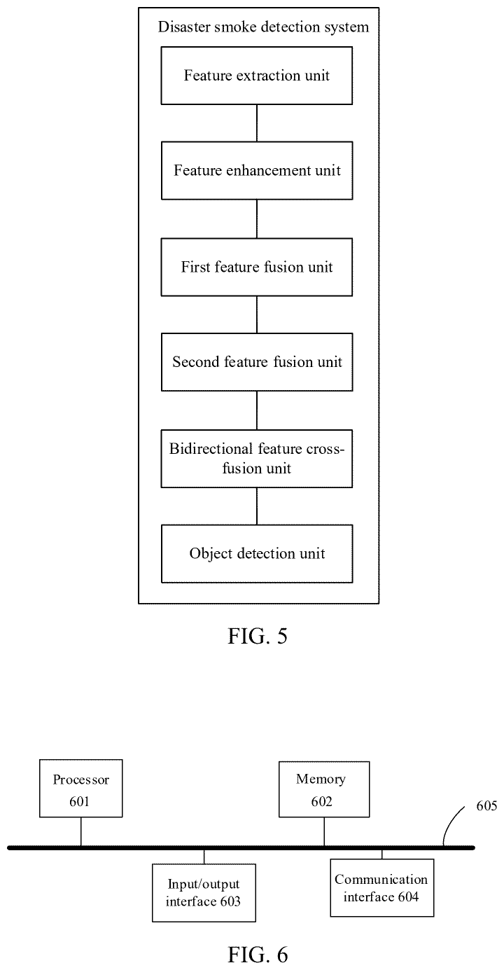

Referring to FIG. 5, an embodiment of the present disclosure further provides a disaster smoke detection system based on a deep convolutional neural network. The system can implement the disaster smoke detection method based on a deep convolutional neural network. The system includes:
a feature extraction unit configured for performing a first convolution operation on an input image to extract features to generate a primary feature map;
a feature enhancement unit configured for performing enhancement processing on the primary feature map to obtain an enhanced feature map;
a first feature fusion unit configured for performing multi-scale fusion on the enhanced feature map according to a second convolution operation to obtain a plurality of feature maps of different scales as high-level feature maps;
a second feature fusion unit configured for respectively performing top-down feature fusion and bottom-up feature fusion on each high-level feature map at each scale according to a third convolution operation to correspondingly obtain a plurality of top-down fused feature maps and a plurality of bottom-up fused feature maps;
a bidirectional cross-fusion unit configured for fusing the top-down fused feature maps and the bottom-up fused feature maps to obtain a plurality of bidirectional cross-fused feature maps; and
an object detection unit configured for performing disaster and smoke detection on each of the bidirectional cross-fused feature maps.

It can be understood that the contents of the above method embodiments also apply to this system embodiment. Functions implemented in this system embodiment are the same as those in the above method embodiments, and this system embodiment can achieve the same beneficial effects as those achieved in the above method embodiments.

An embodiment of the present disclosure further provides an electronic device, including a memory and a processor. The memory has a computer program stored therein. The computer program, when executed by the processor, causes the processor to implement the disaster smoke detection method based on a deep convolutional neural network. The electronic device may include any smart terminal such as a tablet computer or an in-vehicle computer.

It can be understood that the contents of the above method embodiments also apply to this device embodiment. Functions implemented in this device embodiment are the same as those in the above method embodiments, and this device embodiment can achieve the same beneficial effects as those achieved in the above method embodiments.

FIG. 6 shows a hardware structure of an electronic device according to another embodiment. Referring to FIG. 6, the electronic device includes a processor 901, a memory 902, an input/output interface 903, a communication interface 904, and a bus 905.

The processor 601 may be implemented by a general-purpose Central Processing Unit (CPU), a microprocessor, an Application Specific Integrated Circuit (ASIC), or one or more integrated circuits, and is configured for executing a related program to implement the technical schemes provided by the embodiments of the present disclosure.

The memory 602 may be implemented in the form of a Read Only Memory (ROM), a static storage device, a dynamic storage device, a Random Access Memory (RAM), etc. The memory 602 may store an operating system and other application programs. When the technical schemes provided by the embodiments of the present disclosure are implemented by software or firmware, related program code is stored in the memory 602, and is called by the processor 601 to execute the disaster smoke detection method based on a deep convolutional neural network according to the embodiments of the present disclosure.

The input/output interface 603 is configured for enabling input and output of information.

The communication interface 604 is configured for realizing communication interaction between the electronic device and other devices, either through wired communication (e.g., USB, network cable, etc.) or through wireless communication (e.g., mobile network, Wi-Fi, Bluetooth, etc.).

The bus 605 is configured for transmitting information between components of the electronic device (such as the processor 601, the memory 602, the input/output interface 603, and the communication interface 604).

The processor 601, the memory 602, the input/output interface 603, and the communication interface 604 are in communication connection with each other inside the electronic device through the bus 605.

An embodiment of the present disclosure further provides a computer-readable storage medium, having a computer program stored therein. The computer program, when executed by a processor, causes the processor to implement the disaster smoke detection method based on a deep convolutional neural network.

It can be understood that the contents of the above method embodiments also apply to this storage medium embodiment. Functions implemented in this storage medium embodiment are the same as those in the above method embodiments, and this storage medium embodiment can achieve the same beneficial effects as those achieved in the above method embodiments.

The memory, as a non-transitory computer-readable storage medium, may be configured for storing a non-transitory software program and a non-transitory computer-executable program. In addition, the memory may include a high speed random access memory, and may also include a non-transitory memory, e.g., at least one magnetic disk storage device, flash memory device, or other non-transitory solid-state storage device. In some implementations, the memory may include memories located remotely from the processor, and the remote memories may be connected to the processor via a network. Examples of the network include, but are not limited to, the Internet, an intranet, a local area network, a mobile communication network, and combinations thereof.

The contents described in the embodiments of the present disclosure are for the purpose of illustrating the technical schemes of the embodiments of the present disclosure more clearly, and do not constitute a limitation on the technical schemes provided in the embodiments of the present disclosure. Those of ordinary skills in the art may know that with the evolution of technologies and the emergence of new application scenarios, the technical schemes provided in the embodiments of the present disclosure are also applicable to similar technical problems.

Those having ordinary skills in the art may understand that the technical scheme shown in the drawings does not constitute a limitation to the embodiments of the present disclosure, and more or fewer operations than those shown in the drawings may be included, or some operations may be combined, or different operations may be used.

The system embodiments described above are merely examples. The units described as separate components may or may not be physically separated, i.e., may be located in one place or may be distributed over a plurality of network units. Some or all of the modules may be selected according to actual needs to achieve the objectives of the schemes of the embodiments of the present disclosure.

Those having ordinary skills in the art can understand that all or some of the operations in the methods disclosed above and the functional modules/units in the system and the apparatus can be implemented as software, firmware, hardware, and appropriate combinations thereof.

In the specification and accompanying drawings of the present disclosure, the terms “first,” “second,” “third,” “fourth,” and so on (if any) are intended to distinguish between similar objects, but do not necessarily indicate a specific order or sequence. It is to be understood that the data termed in such a way are interchangeable in appropriate circumstances, so that the embodiments of the present disclosure described herein can be implemented in orders other than the order illustrated or described herein. Moreover, the terms “include,” “comprise,” and any other variants thereof are intended to cover a non-exclusive inclusion. For example, a process, method, system, product, or device that includes a list of operations or units is not necessarily limited to those expressly listed operations or units, but may include other operations or units not expressly listed or inherent to such a process, method, product, or device.

It is to be understood that in the present disclosure, “at least one” means one or more and “a plurality of” means two or more. The term “and/or” is used for describing an association between associated objects and representing that three associations may exist. For example, “A and/or B” may indicate that only A exists, only B exists, and both A and B exist, where A and B may be singular or plural. The character “/” generally indicates an “or” relationship between the associated objects. “At least one of” and similar expressions refer to any combination of items listed, including one item or any combination of a plurality of items. For example, at least one of a, b, or c may represent a, b, c, “a and b,” “a and c,” “b and c,” or “a, b, and c,” where a, b, and c may be singular or plural.

In the several embodiments provided in the present disclosure, it is to be understood that the disclosed system and method may be implemented in other manners. For example, the system embodiments described above are merely exemplary. For example, the division of the units is merely a logical function division and other division manners may be used in practical implementations. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the systems or units may be implemented in electronic, mechanical, or other forms.

The units described as separate parts may or may not be physically separate. Parts displayed as units may or may not be physical units, and may be located in one position, or may be distributed on a plurality of network units. Some or all of the units may be selected according to actual needs to achieve the objectives of the schemes in the embodiments of the present disclosure.

In addition, functional units in the embodiments of the present disclosure may be integrated into one processing unit, or each of the units may exist alone physically, or two or more units may be integrated into one unit. The integrated unit may be implemented in the form of hardware, or may be implemented in the form of a software functional unit.

The integrated unit may be stored in a computer-readable storage medium if implemented in the form of a software functional unit and sold or used as an independent product. Based on such an understanding, the technical schemes of the present disclosure essentially, or the part contributing to the related art, or all or some of the technical schemes may be implemented in the form of a software product. The software product is stored in a storage medium, and includes several instructions for instructing a computer device (which may be a personal computer, a server, a network device, or the like) to execute all or some of the operations of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disk.

Although some embodiments of the present disclosure are described above with reference to the accompanying drawings, these embodiments are not intended to limit the protection scope of the present disclosure. Any modifications, equivalent replacements and improvements made by those having ordinary skills in the art without departing from the scope and essence of the embodiments of the present disclosure shall fall within the protection scope of the embodiments of the present disclosure.

What is claimed is:

1. A disaster smoke detection method based on a deep convolutional neural network, comprising:
performing a first convolution operation on an input image to extract features to generate a primary feature map;
performing enhancement processing on the primary feature map to obtain an enhanced feature map;
performing multi-scale fusion on the enhanced feature map according to a second convolution operation to obtain a plurality of feature maps of different scales as high-level feature maps;
respectively performing top-down feature fusion and bottom-up feature fusion on each high-level feature map at each scale according to a third convolution operation to correspondingly obtain a plurality of top-down fused feature maps and a plurality of bottom-up fused feature maps;
fusing the top-down fused feature maps and the bottom-up fused feature maps to obtain a plurality of bidirectional cross-fused feature maps; and
performing disaster and smoke detection on each of the bidirectional cross-fused feature maps,
wherein the performing a first convolution operation on an input image to extract features to generate a primary feature map comprises:
performing a convolution operation on the input image through a spatial and channel reconstruction convolution module to obtain a basic feature map,
wherein the convolution operation of the spatial and channel reconstruction convolution module is expressed as the following formula:
$${X}^{′} = ScConv ( X ) = {σ}_{act} ( BN ( CRU ( SRU ( Conv ( X ) ) ) ) ) ,$$
where X′ represents the basic feature map; ScConv represents a spatial and channel reconstruction convolution operation; Conv(X) represents a convolution operation of the input image X with a weight W, with a kernel size of k×k and a stride s, using automatic padding p to adjust a size of a feature map to be outputted; SRU(X) is used for handling spatial redundancy; CRU(X) is used for handling channel redundancy; BN(·) represents a batch normalization operation; and σ_{act}(·) represents an SiLU activation function; and
performing a convolution operation on the basic feature map through a residual block to obtain the primary feature map,
wherein the convolution operation of the residual block is expressed as the following formula:
$$F ( {X}^{′} ) = S c C o n {v}_{2} ( {σ}_{act} ( B {N}_{1} ( S c C o n {v}_{1} ( {X}^{′} ) ) ) ) ;$$
and
residual connection of the residual block is expressed as the following formula:
$${Y}^{′} = {X}^{′} + F ( {X}^{′} ) ,$$
where ScConv₁ and ScConv₂ represent two consecutive spatial and channel reconstruction convolution operations, F(X′) represents a convolved feature mapping, and Y′ the primary feature map; and
wherein the performing enhancement processing on the primary feature map to obtain an enhanced feature map comprises:
generating a weight matrix corresponding to the primary feature map through a convolution operation of an attention mechanism, and performing element-wise multiplication on the weight matrix and the primary feature map to obtain a first intermediate feature map,
wherein the convolution operation of the attention mechanism is expressed as the following formula:
$$A = Sigmoid ( {Conv}_{a t t} ( {Y}^{′} ) ) ,$$
where A represents the weight matrix, Convₐₜₜ represents the convolution operation that generates the weight matrix, and Sigmoid represents a function for generating a normalized output; and the first intermediate feature map is defined as Z′, and Z′=A⊙Y′;
generating an offset amount of a deformable convolutional layer of the first intermediate feature map through a local convolution operation, and performing a deformable convolution operation according to the offset amount of the deformable convolutional layer and the first intermediate feature map to obtain a second intermediate feature map,
wherein the offset amount of the deformable convolutional layer is expressed as the following formula:
$$Δ p = C o n {v}_{offset} ( {Z}^{′} ) ;$$
and
wherein the deformable convolution operation is expressed as the following formula:
$${Z}^{″} = DeformConv ( {Z}^{′} , Δ p ) ,$$
where Δp represents the offset amount of the deformable convolutional layer, Conv_{offset} represents a convolution operation of an independent convolutional layer, DeformConv represents the deformable convolution operation, and Z″ represents the second intermediate feature map;
performing Gabor filtering processing on the second intermediate feature map to obtain a filtered feature map,
wherein the Gabor filtering processing is expressed as the following formula:
$$G ( x , y ) = exp ( - \frac{{x}^{2} + {γ}^{2} {y}^{2}}{2 {{σ}_{gabor}}^{2}} ) cos ( 2 π \frac{x}{λ} + ψ ) ,$$
where σ_{gabor} is used for controlling a width of a Gaussian function, γ is used for controlling an aspect ratio of an elliptical Gaussian distribution, λ represents a wavelength, ψ represents a phase offset, and x, y represents pixel coordinates; and
adjusting a brightness and contrast of the filtered feature map to obtain the enhanced feature map.

2. The disaster smoke detection method based on a deep convolutional neural network of claim 1, wherein the performing multi-scale fusion on the enhanced feature map according to a second convolution operation to obtain a plurality of feature maps of different scales as high-level feature maps comprises:
performing maximum pooling operations of different scales on the enhanced feature map to obtain a plurality of maximum pooled feature maps;
splicing the maximum pooled feature maps to obtain a spliced feature map, and inputting the spliced feature map to a target convolutional layer for fusion to obtain a multi-scale feature map; and
enhancing a feature of a target region in the multi-scale feature map through an attention mechanism to obtain the high-level feature maps.

3. The disaster smoke detection method based on a deep convolutional neural network of claim 1, wherein the respectively performing top-down feature fusion and bottom-up feature fusion on each high-level feature map at each scale according to a third convolution operation to correspondingly obtain a plurality of top-down fused feature maps and a plurality of bottom-up fused feature maps comprises:
converting a number of channels of each of the high-level feature maps to a consistent dimension through a 1×1 convolution operation to obtain a plurality of converted feature maps;
starting from the converted feature map of a highest layer of the scale, propagating the converted feature maps downward layer by layer through interpolation upsampling, and performing weighted fusion with the converted feature map of a next layer to obtain a first fused feature map,
wherein the first fused feature map is expressed as the following formula:
$${P}_{i}^{T D} = {α}_{i , 1} \cdot {P}_{i} + {α}_{i , 2} \cdot Up ( {\tilde{P}}_{i + 1}^{T D} ) ,$$
where
$${P}_{i}^{TD}$$
represents the first fused feature map, Pᵢ represents the converted feature map, Up(·) represents an upsampling operation,
$${\tilde{P}}_{i + 1}^{TD}$$
represents a feature map obtained by depthwise separable convolution, α_{i,1} and α_{i,2} represent learnable first fusion weights, and the first fusion weights are constrained to be non-negative by a ReLU function;
starting from the converted feature map of a lowest layer of the scale, propagating the converted feature maps upward layer by layer through downsampling, and performing weighted fusion with the converted feature map of a previous layer to obtain a second fused feature map,
wherein the second fused feature map is expressed as the following formula:
$${P}_{i}^{BU} = {β}_{i , 1} \cdot {P}_{i}^{TD} + {β}_{i , 2} \cdot {\tilde{P}}_{i} + {β}_{i , 3} \cdot Down ( {P}_{i - 1}^{BU} ) ,$$
where
$${P}_{i}^{BU}$$
represents the second fused feature map, Down(·) represents a downsampling operation, \tilde{P}ᵢ represents a feature map obtained by depthwise separable convolution, and β_{i,1}, β_{i,2}, and β_{i,3} represent learnable second fusion weights; and
adjusting the first fusion weights and the second fusion weights according to a minimization loss function through a back propagation algorithm, generating the top-down fused feature maps using the adjusted first fusion weights, and generating the bottom-up fused feature maps using the adjusted second fusion weights,
wherein the minimization loss function is expressed as the following formula:
$$L = {Σ}_{i = 2}^{6} {L}_{t a s k} ( {F}_{i}^{TD} , {F}_{i}^{BU} ) ;$$
wherein the top-down fused feature map is expressed as the following formula:
$${F}_{i}^{TD} = {α}_{i , 1} \cdot {P}_{i}^{TD} + {α}_{i , 2} \cdot Up ( {F}_{i + 1}^{TD} ) ;$$
and
wherein the bottom-up fused feature map is expressed as the following formula:
$${F}_{i}^{BU} = {β}_{i , 1} \cdot {P}_{i}^{BU} + {β}_{i , 2} \cdot {P}_{i} + {β}_{i , 3} \cdot Down ( {F}_{i - 1}^{BU} ) ,$$
where L represents the minimization loss function,
$${F}_{i}^{TD}$$
represents the top-down fused feature map,
$${F}_{i}^{BU}$$
represents the bottom-up fused feature map, and i represents a hierarchical sequence number of the converted feature map; and
wherein the fusing the top-down fused feature maps and the bottom-up fused feature maps to obtain a plurality of bidirectional cross-fused feature maps comprises:
determining an optimized fusion weight according to the adjusted first fusion weights and the adjusted second fusion weights; and
fusing the top-down fused feature maps and the bottom-up fused feature maps according to the optimized fusion weight to obtain the plurality of the bi-directional cross-fused feature maps,
wherein the bidirectional cross-fused feature map is expressed as the following formula:
$${F}_{i} = {\sum }_{i = 2}^{6} {γ}_{i} \cdot ( {F}_{i}^{T D} + {F}_{i}^{BU} ) ,$$
where Fᵢ represents the bidirectional cross-fused feature map, and γᵢ represents the optimized fusion weight.

4. The disaster smoke detection method based on a deep convolutional neural network of claim 1, wherein the performing disaster and smoke detection on each of the bidirectional cross-fused feature maps comprises:
identifying categories of objects in each of the bidirectional cross-fused feature maps through a classification convolution operation to obtain a classification result, wherein the objects comprise disaster and smoke; and
the classification result is expressed as the following formula:
$${F}_{i , cls} = {σ}_{c l s} ( B N ( C o n {v}_{c l s} ( {F}_{i} ) ) ) ,$$
where F_{i,cls} represents the classification result, Conv_{cls} represents the classification convolution operation, BN(·) represents a batch normalization operation, σ_{cls}(·) represents an activation function of classification convolution, and Fᵢ represents the bidirectional cross-fused feature map;
determining a probability of each of the objects according to the classification result and generating a confidence level of each of the probabilities,
wherein a probability distribution of each of the objects is expressed as the following formula:
$$P ( C \vert {F}_{i} ) = Softmax ( {F}_{i , c l s} ) ,$$
where P(C|Fᵢ) represents the probability distribution, C represents the probability, and Softmax represents an activation function;
outputting a bounding box parameter for each of the objects in each of the bidirectional cross-fused feature maps through a regression convolution operation,
wherein the bounding box parameter is expressed as the following formula:
$$B ( {F}_{i} ) = C o n {v}_{reg} ( {F}_{i} ) ,$$
where B(Fᵢ) represents the bounding box parameter, and Conv_{reg} represents the regression convolution operation; and
determining the probability of each of the objects, the confidence level of each of the probabilities, and the bounding box parameter of each of the objects as a detection result of the disaster and smoke detection,
wherein the detection result is expressed as the following formula:
$${O}_{i} = \{ ( C , S ( C \vert {F}_{i} ) , B ( {F}_{i} ) ) \} ,$$
where Oᵢ represents the detection result, and S(C|Fᵢ) represents the confidence level.

5. The disaster smoke detection method based on a deep convolutional neural network of claim 4, further comprising:
optimizing the bounding box parameter using a distributed focal loss to obtain an optimized bounding box parameter,
wherein the optimized bounding box parameter is expressed as the following formula:
$${B}^{′} ( {F}_{i} ) = D F L ( B ( {F}_{i} ) ) ,$$
wherein B′(Fᵢ) represents the optimized bounding box parameter, and DFL represents the distributed focal loss; and
updating the detection result according to the optimized bounding box parameter,
wherein the updated detection result is expressed as the following formula:
$${O}_{i} = \{ ( C , S ( C \vert {F}_{i} ) , {B}^{′} ( {F}_{i} ) ) \} .$$

6. A disaster smoke detection system based on a deep convolutional neural network, comprising:
a feature extraction unit configured for performing a first convolution operation on an input image to extract features to generate a primary feature map;
a feature enhancement unit configured for performing enhancement processing on the primary feature map to obtain an enhanced feature map;
a first feature fusion unit configured for performing multi-scale fusion on the enhanced feature map according to a second convolution operation to obtain a plurality of feature maps of different scales as high-level feature maps;
a second feature fusion unit configured for respectively performing top-down feature fusion and bottom-up feature fusion on each high-level feature map at each scale according to a third convolution operation to correspondingly obtain a plurality of top-down fused feature maps and a plurality of bottom-up fused feature maps;
a bidirectional cross-fusion unit configured for fusing the top-down fused feature maps and the bottom-up fused feature maps to obtain a plurality of bidirectional cross-fused feature maps; and
an object detection unit configured for performing disaster and smoke detection on each of the bidirectional cross-fused feature maps,
wherein the performing a first convolution operation on an input image to extract features to generate a primary feature map comprises:
performing a convolution operation on the input image through a spatial and channel reconstruction convolution module to obtain a basic feature map,
wherein the convolution operation of the spatial and channel reconstruction convolution module is expressed as the following formula:
$${X}^{′} = S c C o n v ( X ) = {σ}_{act} ( BN ( CR U ( S R U ( C o n v ( X ) ) ) ) ) ,$$
where X′ represents the basic feature map; ScConv represents a spatial and channel reconstruction convolution operation; Conv(X) represents a convolution operation of the input image X with a weight W, with a kernel size of k×k and a stride s, using automatic padding p to adjust a size of a feature map to be outputted; SRU(X) is used for handling spatial redundancy; CRU(X) is used for handling channel redundancy; BN(·) represents a batch normalization operation; and π_{act}(·) represents a SiLU activation function; and
performing a convolution operation on the basic feature map through a residual block to obtain the primary feature map,
wherein the convolution operation of the residual block is expressed as the following formula:
$$F ( {X}^{′} ) = S c C o n {v}_{2} ( {σ}_{act} ( B {N}_{1} ( S c C o n {v}_{1} ( {X}^{′} ) ) ) ) ;$$
and
residual connection of the residual block is expressed as the following formula:
$${Y}^{′} = {X}^{′} + F ( {X}^{′} ) ,$$
where ScConv₁ and ScConv₂ represent two consecutive spatial and channel reconstruction convolution operations, F(X′) represents a convolved feature mapping, and Y′ the primary feature map; and
wherein the performing enhancement processing on the primary feature map to obtain an enhanced feature map comprises:
generating a weight matrix corresponding to the primary feature map through a convolution operation of an attention mechanism, and performing element-wise multiplication on the weight matrix and the primary feature map to obtain a first intermediate feature map,
wherein the convolution operation of the attention mechanism is expressed as the following formula:
$$A = Sigmoid ( {Conv}_{a t t} ( {Y}^{′} ) ) ,$$
where A represents the weight matrix, Convₐₜₜ represents the convolution operation that generates the weight matrix, and Sigmoid represents a function for generating a normalized output; and the first intermediate feature map is defined as Z′, and Z′=A⊙Y′;
generating an offset amount of a deformable convolutional layer of the first intermediate feature map through a local convolution operation, and performing a deformable convolution operation according to the offset amount of the deformable convolutional layer and the first intermediate feature map to obtain a second intermediate feature map,
wherein the offset amount of the deformable convolutional layer is expressed as the following formula:
$$Δ p = C o n {v}_{offset} ( {Z}^{′} ) ;$$
and
wherein the deformable convolution operation is expressed as the following formula:
$${Z}^{″} = DeformConv ( {Z}^{′} , Δ p ) ,$$
where Δp represents the offset amount of the deformable convolutional layer, Conv_{offset} represents a convolution operation of an independent convolutional layer, DeformConv represents the deformable convolution operation, and Z″ represents the second intermediate feature map;
performing Gabor filtering processing on the second intermediate feature map to obtain a filtered feature map,
wherein the Gabor filtering processing is expressed as the following formula:
$$G ( x , y ) = exp ( - \frac{{x}^{2} + {γ}^{2} {y}^{2}}{2 {σ}_{gabor}^{2}} ) cos ( 2 π \frac{x}{λ} + ψ ) ,$$
where σ_{gabor} is used for controlling a width of a Gaussian function, γ is used for controlling an aspect ratio of an elliptical Gaussian distribution, λ represents a wavelength, ψ represents a phase offset, and x, y represents pixel coordinates; and
adjusting a brightness and contrast of the filtered feature map to obtain the enhanced feature map.

7. An electronic device, comprising a memory and a processor, wherein the memory is configured for storing a computer program which, when executed by the processor, causes the processor to perform the method of claim 1.

8. A non-transitory computer-readable storage medium, storing a computer program, wherein the computer program, when executed by a processor, causes the processor to perform the method of claim 1.
